(19) United States
(12) Patent Application Publication
(10) Pub. No.: US 2004/0067760 A1
(43) Pub. Date: Apr. 8, 2004

(54) Winner deciding system, winner deciding method, winner deciding program, and computer-readable recording medium

(75) Inventors: Hiroyuki Menjo, Kawasaki-shi (JP); Atsushi Odakura, Tokyo (JP); Maki Fujiwara, Kawasaki-shi (JP); Hiroyuki Yamamoto, Tokyo (JP); Katsutoshi Murata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Tokyo (JP)

(21) Appl. No.: 10/671,470

(22) Filed: Sep. 29, 2003

(30) Foreign Application Priority Data
Oct. 7, 2002 (JP) 2002-294157

(51) Int. Cl. H04Q 7/20

(52) U.S. Cl. 455/456.1; 455/435.1; 455/433

(57) ABSTRACT

This winner deciding system includes an information transmitting unit for transmitting preliminary information related to a winning location to a mobile device used by a user, a location receiving unit for receiving location information for specifying a location of the mobile device from the mobile device which has received the preliminary information, a winner deciding unit for deciding a winning mobile device, and a winning result transmitting unit for transmitting a winning result to the decided mobile device.

### BACKGROUND OF THE INVENTION

1. Field of the Invention

The present invention relates to a winner deciding system, a winner deciding method, a winner deciding program, and a computer-readable recording medium.

2. Related Background of the Invention

Heretofore, there have been various methods of deciding a winner among a population. Such methods include, for example, a method of deciding a winner at random among the population, a method of allocating arbitrary number strings (or symbol strings) to respective participants and then deciding a winning number string, a method of a so-called “lottery”, and a method of allowing participants to forecast a result of a game such as a football game and thereby deciding a winner. These various methods of deciding a winner may have significance in an act of deciding the winner itself, or significance in utilizing part of money collected from the participants.

### SUMMARY OF THE INVENTION

However, among the conventional methods of deciding a winner, there have been no methods which have significance in attracting the participants to directly come to a predetermined place. For example, a lottery sale held by a department store intends to bring nearby customers to the department store. Nevertheless, such an event is nothing more than a “lottery” to the participants. Such event sales would not be attractive enough to bring the customers who are not interested in the “lottery” itself.

Accordingly, it is an object of the present invention to provide a winner deciding system, a winner deciding method, a winner deciding program, and a computer-readable recording medium, which are capable of attracting participants to a predetermined place more effectively.

To attain the foregoing object, a winner deciding system of the present invention includes: information transmitting means for transmitting preliminary information related to a winning location to a mobile device used by a user; location receiving means for receiving location information specifying a location of the mobile device from the mobile device which has received the preliminary information; winner deciding means for deciding a winning mobile device based on the received location information and the winning location; and winning result transmitting means for transmitting a winning result at least to the decided mobile device.

A winner deciding method of the present invention includes: an information transmitting step of allowing information transmitting means to transmit preliminary information related to a winning location to a mobile device used by a user; a location receiving step of allowing location receiving means to receive location information specifying a location of the mobile device from the mobile device which has received the preliminary information; a winner deciding step of allowing winner deciding means to decide a winning mobile device based on the received location information and the winning location; and a winning result transmitting step of allowing winning result transmitting means to transmit a winning result at least to the decided mobile device.

A winner deciding program of the present invention causes a computer to function as: information transmitting means for transmitting preliminary information related to a winning location to a mobile device used by a user; location receiving means for receiving location information specifying a location of the mobile device from the mobile device which has received the preliminary information; winner deciding means for deciding a winning mobile device based on the received location information and the winning location; and winning result transmitting means for transmitting a winning result at least to the decided mobile device.

According to the winner deciding system or the winner deciding method of the present invention, the preliminary information is transmitted to the mobile S device so that the user can obtain the information related to the winning location. Thereafter, the winning mobile device is decided based on the location information transmitted from the user by use of the mobile device and on the winning location. Accordingly, it is possible to relate the location of the mobile device with the winning location, and thereby to attract the user of the mobile device to a specific location. A similar effect is achieved by executing the winner deciding program of the present invention with a computer.

Moreover, in the winner deciding system, the winner deciding method, and the winner deciding program of the present invention, it is preferable that the preliminary information includes at least image information related to the winning location. When the image information related to the winning location is transmitted to the mobile device, the user can visually obtain the information related to the winning location. Therefore, the preliminary information functions as an incentive for the user to move to the winning location.

Further, in the winner deciding system, the winner deciding method, and the winner deciding program of the present invention, it is preferable that the preliminary information includes at least sound information related to the winning location. When the sound information related to the winning location is transmitted to the mobile device, the user can aurally obtain the information related to the winning location. Thus, the preliminary information functions as an incentive for the user to move to the winning location, and the above function is particularly effective for visually impaired people.

Moreover, in the winner deciding system, the winner deciding method, and the winner deciding program of the present invention, it is preferable that the information transmitting means transmits the preliminary information in response to a request from the mobile device. Since the preliminary information is transmitted to the mobile device which has sent the request, it is possible to reduce transmission of the preliminary information to mobile devices which do not need the preliminary information.

A computer-readable recording medium of the present invention stores any one of the above-described winner deciding programs. When the winner deciding program recorded in the recording medium of the present invention is executed, the preliminary information is transmitted to the mobile device. Accordingly, the user can obtain the information related to the winning location. Thereafter, the winning mobile device is decided based on the location information transmitted from the user by use of the mobile device and on the winning location. Accordingly, it is possible to relate the location of the mobile device with the winning location, and thereby to attract the user of the mobile device to a specific location.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiment of the invention, are given by way of illustration only, since various changes and modifications within the spirit and scope of the invention will become apparent to those skilled in the art from this detailed description.

### BRIEF DESCRIPTION OF THE DRAWINGS

The present invention may be more readily described with reference to the accompanying drawings, in which:

FIG. 1 is a diagram for describing a winner deciding system which is an embodiment of the present invention;

FIG. 2 is a view showing an example of information to be stored in a question information storage unit of FIG. 1;

FIG. 3 is a view showing another example of the information to be stored in the question information storage unit of FIG. 1;

FIG. 4 is a view showing an example of information to be stored in a registration information storage unit of FIG. 1;

FIG. 5 is a flowchart showing a method of deciding a winning terminal by use of the winner deciding system which is the embodiment of the present invention;

FIG. 6 is a diagram for describing a winner deciding program which is an embodiment of the present invention; and

FIG. 7 is another diagram for describing the winner deciding system which is the embodiment of the present invention.

### DESCRIPTION OF THE PREFERRED EMBODIMENTS

The knowledge of the present invention can be readily understood by considering the following detailed description with reference to the accompanying drawings which are given by way of illustration only. Next, embodiments of the present invention will be described with reference to the accompanying drawings. When possible, the same elements are designated by the same reference numerals and duplicate description thereof will be omitted.

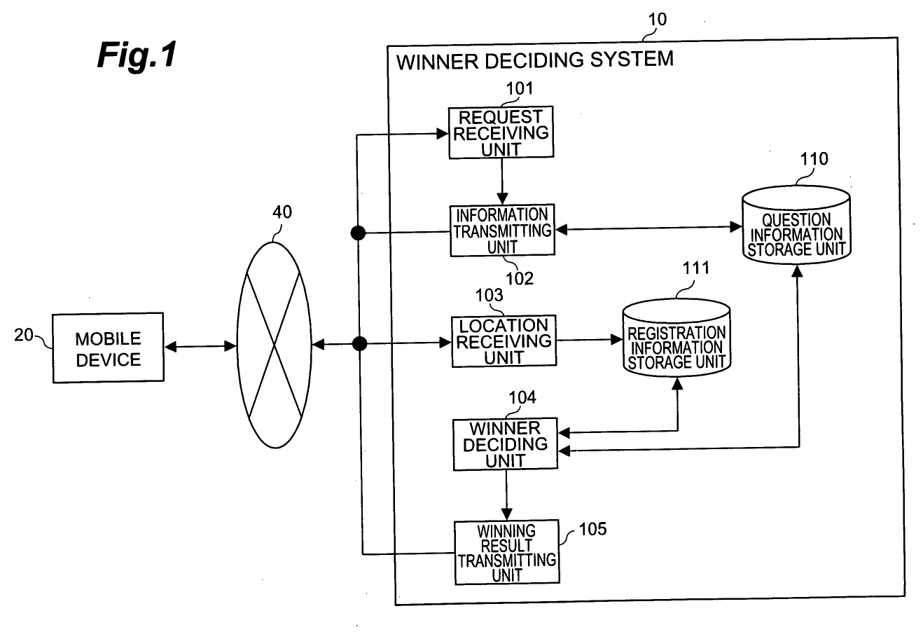

Now description will be made regarding a winner deciding system 10 which is an embodiment of the present invention by use of FIG. 1. FIG. 1 is a diagram for describing the winner deciding system 10. The winner deciding system 10 is configured to be capable of communicating with a mobile device 20 through a wireless network 40.

The mobile device 20 is a cellular phone having a data communication function. The mobile device 20 adopts the personal digital cellular (PDC) system, which is one of the time division multiple access (TDMA) systems. However, the mobile device 20 may be a digital cellular phone adopting other systems such as the code division multiple access (CDMA) system or the general packet radio service (GPRS) system. Thus, the mobile device 20 may adopt various systems which are capable of data communication as appropriate. Moreover, the mobile device 20 may adopt a so-called third-generation mobile communication system such as the IMT-2000. Alternatively, the mobile device 20 may be a mobile information terminal such as a personal digital assistance (PDA) having a communication function instead of a cellular phone. In this way, various devices which are capable of information communication can be used. Meanwhile, the mobile device 20 has a function of a global positioning system (GPS), whereby the mobile device 20 can figure out its own location and thereby obtain the location information. Here, the mobile device 20 may be allowed to obtain the location information by means of base station positioning using a base station signal.

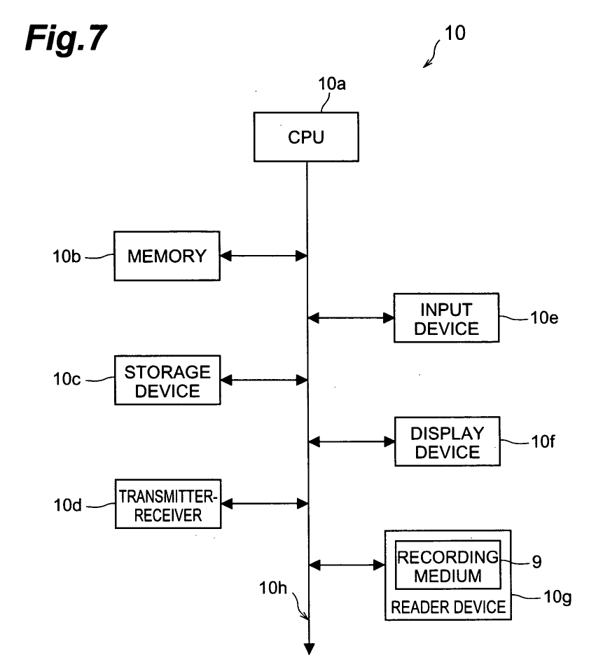

FIG. 7 shows a physical configuration of the winner deciding system 10. The winner deciding system 10 is physically configured as a computer system which includes a central processing unit (CPU) 10a, a memory 10b such as a random access memory (RAM), a storage device 10c such as a hard disk, a transmitter-receiver 10d such as a communication card for transmitting and receiving data to and from the mobile device 20, an input device 10e such as a mouse or a keyboard, a display device 10f such as a display unit, and a reader device 10g which can read information recorded on a recording medium 9 such as a flexible disk drive device, a CD-ROM drive device, or a magnetic tape drive device. Moreover, the CPU 10a, the memory 10b, the storage device 10c, the transmitter-receiver 10d, the input device 10e, and the display device 10f are electrically connected to one another through a bus 10h so as to allow input and output of various signals.

Back to FIG. 1, in terms of functional components, the winner deciding system 10 includes a request receiving unit 101, an information transmitting unit (information transmitting means) 102, a location receiving unit (location receiving means) 103, a winner deciding unit (winner deciding means) 104, a winning result transmitting unit (winning result transmitting means) 105, a question information storage unit 110, and a registration information storage unit 111. Now, description will be made further in detail regarding the respective components.

The request receiving unit 101 is a unit for receiving a question request which is transmitted from the mobile device 20. To be more specific, when a user who intends to participate in a lottery conducted by the winner deciding system accesses the winner deciding system 10 by use of the mobile device 20 and transmits information for requesting transmission of a question to the winner deciding system 10, the request receiving unit 101 receives the information and outputs the information to the information transmitting unit 102.

The information transmitting unit 102 is a unit for selecting a question as preliminary information related to a winning location and transmitting the question to the mobile device 20 in response to the question request outputted from the request receiving unit 101. To be more specific, the information transmitting unit 102 selects the question as image information, a hint as text information, and a question ID, all of which are stored in the question information storage unit 110, and transmits the question, the hint, and the question ID to the mobile device 20.

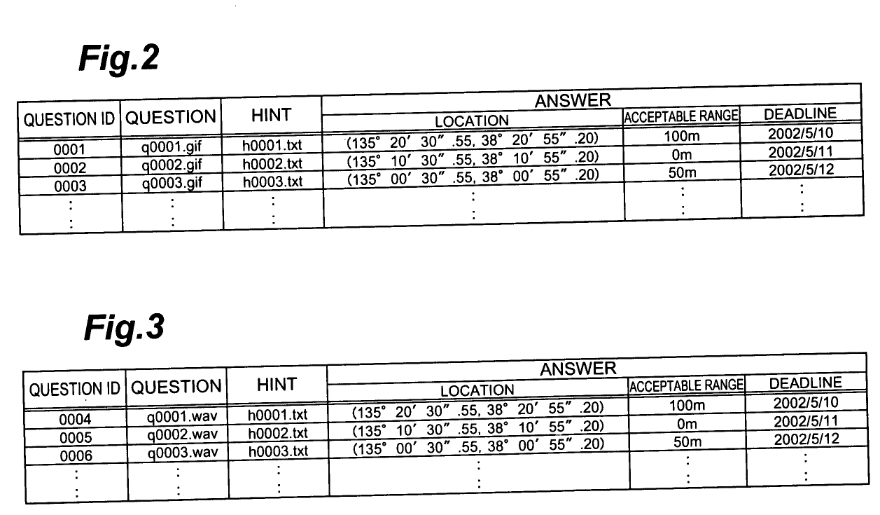

FIG. 2 shows an example of the information stored in the question information storage unit 110. As shown in FIG. 2, “question IDs”, “questions”, “hints”, and “answers” are mutually correlated and stored in the question information storage unit 110. The “answers” include information such as “locations”, “acceptable ranges”, and “deadlines”. The “question ID” is a symbol string for identifying respective questions. The “question” is the image information related to the winning location, and the “hint” is text information related to the winning location. The “location” in the “answer” is longitudinal and latitudinal information of the winning location. The “acceptable range” is a value to be an index in deciding how much deviation from the winning location can be treated as winning. The “deadline” is information indicating an expiration date of the question. For example, when the information transmitting unit 102 selects the question ID “0001”, the information transmitting unit 102 transmits the image information “q0001.gif” and the text information “h0001.txt” to the mobile device together with the question ID “0001”. The text information “h0001.txt” is information to indicate a location when the user cannot figure out the location only with the image information “q0001.gif”. This embodiment shows the case where the “deadlines” are used. However, in order to realize a mode of registering the questions in advance, it is also possible to deal with time period information such as “start reception” or “terminate reception” instead of the information on the “deadlines”.

FIG. 3 shows another example of the information stored in the question information storage unit 110. As shown in FIG. 3, the “question IDs”, the “questions”, the “hints”, and the “answers” are mutually correlated and stored in the question information storage unit 110. The “answers” include information such as the “locations”, the “acceptable ranges”, and the “deadlines”. The difference from the example shown in FIG. 2 is that the “question” is sound information related to the winning location. For example, the sound information related to the winning location is “the Kamata March” when the winning location is “Kamata Station”. The sound information related to the winning location is “New York, N.Y.” when the winning location is “the Yankee Stadium”. The sound information related to the winning location is “London Bridge” when the winning location is “Thames Riverside”. The sound information related to the winning location is “Suzhou Serenade” when the winning location is “Han Shan Temple in Suzhou”. The sound information related to the winning location is “Come Back to Pusan Port” when the winning location is “the Pusan Port”. There may be a case where the winning location and the sound information related to the winning location do not have a one-on-one relation. For example, “Takeda Castle in Takeda City of Oita Prefecture” and “Toyama Castle in Toyama Prefecture” may be the winning locations for the sound information “Moon over Ruined Castle”.

The location receiving unit 103 is a unit which receives location information specifying the location of the mobile device 20 from the mobile device 20 to which the information transmitting unit 102 has sent the preliminary information. More specifically, the location receiving unit 103 receives the location information transmitted by the mobile device 20, the question ID, and information specifying the mobile device 20 (for example, a cellular phone number or terminal ID), correlates them and stores them in the registration information storage unit 111.

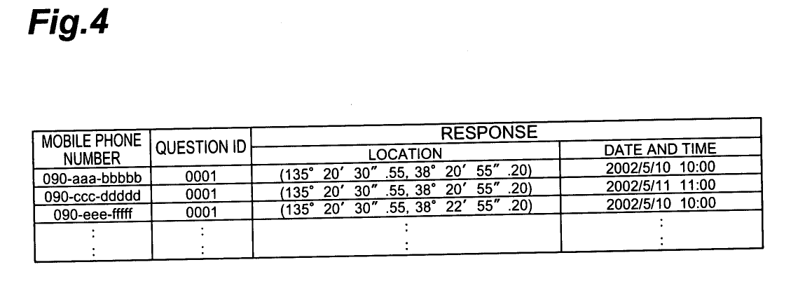

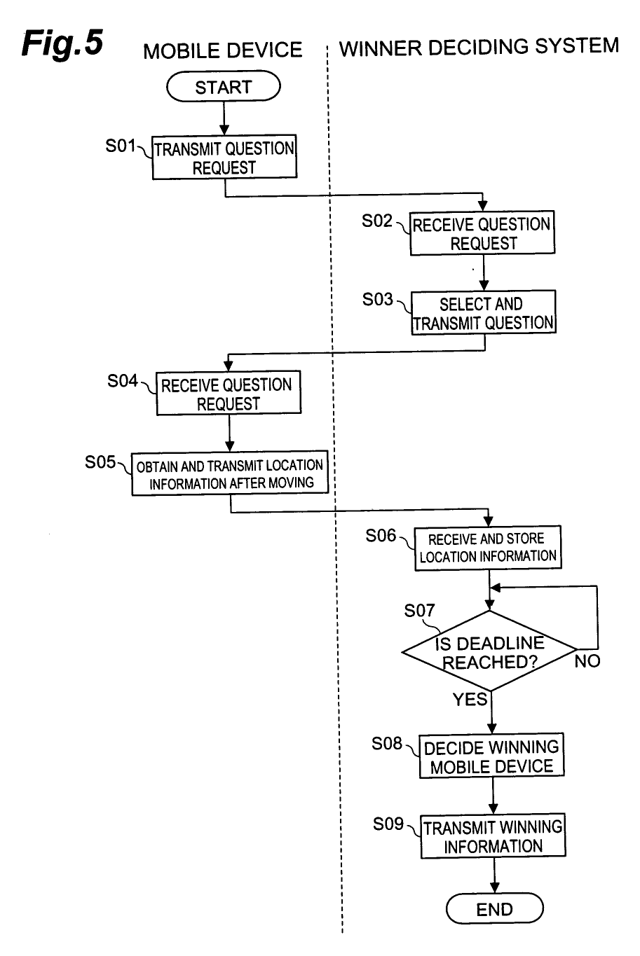

FIG. 4 shows an example of the information stored in the registration information storage unit 111. As shown in FIG. 4, “cellular phone numbers”, the “question IDs”, and “responses” are mutually correlated and stored in the registration information storage unit 111. The “responses” include information such as the “locations” and “date and time”. The “cellular phone number” is a telephone number of the mobile device 20. The “question ID” is the question ID transmitted by the information transmitting unit 102. The “location” in the “response” is transmitted location information from the user using the mobile device 20. Here, the user transmits the location information by assuming the winning location from the question and the hint transmitted from the information transmitting unit 102, moving to the assumed location and obtaining the location information thereof. Similarly, the “date and time” in the “response” is the date and time information when the user using the mobile device 20 obtained the location information. For example, when the “question ID” is 0001, then the expiration date is May 10, 2002. Since the date and time of the response from the user having the mobile phone number “090-aaa-bbbbb” is May 10, 2002, the response is valid. Meanwhile, since the date and time of the response from the user having the mobile phone number “090-ccc-ddddd” is May 11, 2002, the response is invalid.

The winner deciding unit 104 is a unit for specifying the winning mobile device 20 based on the location information of the mobile device 20 received by the location receiving unit 103 and the winning location related to the question transmitted by the information transmitting unit 102. To be more specific, the winner deciding unit 104 searches the information on the questions stored in the question information storage unit 110 and selects the information which falls due. The winner deciding unit 104 selects the corresponding registration information stored in the registration information storage unit 111 based on the question ID of the question which falls due. Moreover, the winner deciding unit 104 compares an answer location corresponding to the question ID (E 135° 20′30″.55, N38° 20′55″.20 when the question ID is 0001) with a responded location (see FIG. 4), and specifies the winning cellular phone number, even by considering the acceptable range when applicable. In the example shown in FIG. 4, the terminal having a mobile phone number “090-aaa-bbbbb” satisfies the both of the conditions for wining in terms of date and time as well as the location of response. Meanwhile, the terminal having the mobile phone number “090-ccc-ddddd” satisfies a condition for winning in terms of the location of response, however, the terminal does not satisfy the condition for winning because the date and time of the response is missing the deadline. The terminal having the cellular phone number “090-eee-fffff” does not satisfy the winning condition in terms of the location of response. The winner deciding unit 104 outputs the cellular phone number specified to be winning to the winning result transmitting unit 105.

The winning result transmitting unit 105 is a unit for transmitting information on winning at least to the winning mobile device 20 based on the information outputted from the winner deciding unit 104. Since the cellular phone number is outputted from the winner deciding unit 104, the winning result transmitting unit notifies the winning result to the mobile device 20 corresponding to the cellular phone number. Meanwhile, the winning result transmitting unit 105 may transmit rejection information to the mobile devices other than the winning mobile device. By transmitting the information not only to the winning mobile device but also to the rejected mobile devices, it is possible to promote the rejected participants to challenge once again.

Now, description will be made regarding a method of deciding a winning mobile device by use of the winner deciding system 10. The user using the mobile device 20 transmits the question request to the winner deciding system 10 by use of the mobile device 20 (Step Sol). The request receiving unit 101 of the winner deciding system 10 receives the question request transmitted from the mobile device 20, and outputs the question request to the information transmitting unit 102 (Step S02).

Upon receipt of the question request, the information transmitting unit 102 extracts the question stored in the question information storage unit 110 and transmits the question to the mobile device 20 (Step S03). Upon receipt of the question, the mobile device 20 displays the question on the built-in display unit. The user of the mobile device 20 confirms the question, and moves to the location which the user considers to be related to the image and the sentence displayed thereon (Step S04).

After moving, the user obtains the current location by use of the mobile device 20, and transmits, the information on the current location to the winner deciding system 10 (Step S05). In the event of transmission, the user also transmits the information for identifying the mobile device 20 and the question ID at the same time. The location receiving unit 103 of the winner deciding system stores the information transmitted from the mobile device 20 into the registration information storage unit 111 (Step S06).

The winner deciding unit 104 of the winner deciding system 10 monitors the deadlines of the questions stored in the question information storage unit 110 irrespective of receiving operations by the location receiving unit 103 (Step S07). When a certain question reaches expiration, the winner deciding unit 104 decides the winning terminal among the terminals stored in the registration information storage unit 111 based on the information such as the answer location of the relevant question or the acceptable range thereof (Step S08).

The winning result transmitting unit 105 transmits the result to the winning terminal decided by the winner deciding unit 105 (Step S09).

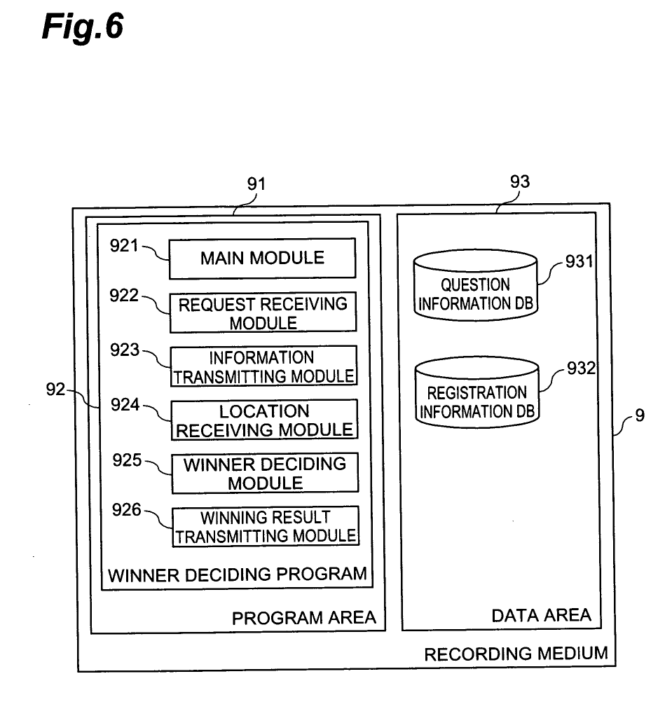

Next, description will be made regarding a winner deciding program 92 for allowing a computer to function as the winner deciding system 10 of this embodiment and a computer-readable recording medium 9 storing the winner deciding program 9. FIG. 6 is a diagram showing a constitution of the recording medium 9 recording the winner deciding program 92. A magnetic disk, an optical disk, a CD-ROM, a memory embedded in a computer and the like can be exemplified as the recording medium 9.

As shown in FIG. 6, the recording medium 9 includes a program area 91 for recording the program and a data area 93 for recording data. The data area 93 stores a question information database 931 and a registration information database 932, which are similar to the question information storage unit 110 and the registration information storage unit 111, respectively, described by use of FIG. 1.

The winner deciding program 92 is recorded in the program area 91. The winner deciding program 92 includes a main module 921 for controlling processing, a request receiving module 922, an information transmitting module 923, a location receiving module 924, a winner deciding module 925, and a winning result transmitting module 926. Here, the functions to be achieved by operating each of the request receiving module 922, the information transmitting module 923, the location receiving module 924, the winner deciding module 925, and the winning result transmitting module 926 are each similar to the functions of the request receiving unit 101, the information transmitting unit 102, the location receiving unit 103, the winner deciding unit 104, and the winning result transmitting unit 105 of the above-described winner deciding system 10, respectively. Here, when the recording medium 9 is inserted into the reader device 10g of the winner deciding system 10 (see FIG. 7), the information recorded on the recording medium 9 becomes accessible through the reader device 10g. Accordingly, it is possible to execute the winner deciding program 92 which is recorded in the program area 91 of the recording medium 9.

An operation and an effect of this embodiment will be described. The winner deciding system 10 transmits the preliminary information (the question, the hint, and the question ID) to the mobile device 20 in response to the request from the mobile device 20. Accordingly, the user can obtain the information related to the winning location. Thereafter, the winning mobile device 20 is decided based on the location information transmitted by the user with the mobile device 20 and on the winning location. Therefore, it is possible to relate the location of the mobile device 20 with the winning location, and thereby to attract the user of the mobile device 20 to a specific location.

Moreover, since the preliminary information includes at least the image information related to the winning location, the image information related to the winning location is transmitted to the mobile device 20. Therefore, the user can visually obtain the information related to the winning location, and the preliminary information functions as an incentive for moving to the winning location. Moreover, if the sound information related to the winning location is included as the preliminary information, the user can aurally obtain the information related to the winning location.

Moreover, the information transmitting unit 102 transmits the preliminary information in response to the request from the mobile device 20. Accordingly, transmission of the preliminary information to mobile devices 20 which do not need the preliminary information is reduced.

Furthermore, according to this embodiment, it is possible to realize the following business model and the like. The information transmitting unit 102 of the winner deciding system 10 retrieves a question such as “Reception accepted from 10 to 12 o'clock on May 10. An electronic lottery will take place in front of the Shop A at 12:30. The winner will receive a gorgeous prize on the spot,” and transmits the question to the mobile device 20. Upon receipt of the question, the user moves to the Shop A before termination of the reception, and transmits his name, the question ID, the location information, and terminal information (such as the telephone number) to the winner deciding system 10. The winner deciding system 10 extracts answer information based on the question ID transmitted from the user, and judges whether or not the information transmitted by the user satisfies predetermined conditions. The winner is decided among the users satisfying the given conditions based on a predetermined lottery condition, and the winning result transmitting unit 105 notifies the winning result.

Moreover, it is also possible to use a lottery rate in deciding a winner. The lottery rate may adopt not only a simple and uniform winning probability, but also a winning probability depending on areas, that is, the probability which is arranged to be higher in the vicinity of a predetermined event site.

Furthermore, it is also possible to arrange the system to enable participants to win a prize if the participants notify the location information from a designated place at a designated time. For example, participants may be provided with prize exchange information corresponding to a location information by transmitting the location information to the winner deciding system 10 in a football stadium at a halftime.

According to the present invention, since the preliminary information is transmitted to the mobile device, the user can obtain the information related to the winning location. Thereafter, the winning mobile device is decided based on the location information transmitted by the user with the mobile device and on the winning location. Accordingly, it is possible to relate the location of the mobile device with the winning location, and thereby to attract the user of the mobile device to a specific location. Therefore, it is possible to provide the winner deciding system, the winner deciding method, the winner deciding program, and the computer-readable recording medium which are capable of attracting the participants to a predetermined place more effectively, which is the object of the present invention.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A winner deciding system comprising:
information transmitting means for transmitting preliminary information related to a winning location to a mobile device used by a user;
location receiving means for receiving location information specifying a location of the mobile device from the mobile device which has received the preliminary information;
winner deciding means for deciding a winning mobile device based on the received location information and the winning location; and
winning result transmitting means for transmitting a winning result at least to the decided mobile device.

2. The winner deciding system according to claim 1, wherein the preliminary information includes at least image information related to the winning location.

3. The winner deciding system according to claim 1, wherein the preliminary information includes at least sound information related to the winning location.

4. The winner deciding system according to claim 1, wherein the information transmitting means transmits the preliminary information in response to a request from the mobile device.

5. A winner deciding method comprising:
an information transmitting step of allowing information transmitting means to transmit preliminary information related to a winning location to a mobile device used by a user;
a location receiving step of allowing location receiving means to receive location information specifying a location of the mobile device from the mobile device which has received the preliminary information;
a winner deciding step of allowing winner deciding means to decide a winning mobile device based on the received location information and the winning location; and
a winning result transmitting step of allowing winning result transmitting means to transmit a winning result at least to the decided mobile device.

6. The winner deciding method according to claim 5, wherein the preliminary information includes at least image information related to the winning location.

7. The winner deciding method according to claim 5, wherein the preliminary information includes at least sound information related to the winning location.

8. The winner deciding method according to claim 5, wherein the information transmitting means transmits the preliminary information in response to a request from the mobile device.

9. A winner deciding program causing a computer to function as:
information transmitting means for transmitting preliminary information related to a winning location to a mobile device used by a user;
location receiving means for receiving location information specifying a location of the mobile device from the mobile device which has received the preliminary information;
winner deciding means for deciding a winning mobile device based on the received location information and the winning location; and
winning result transmitting means for transmitting a winning result at least to the decided mobile device.

10. The winner deciding program according to claim 9, wherein the preliminary information includes at least image information related to the winning location.

11. The winner deciding program according to claim 9, wherein the preliminary information includes at least sound information related to the winning location.

12. The winner deciding program according to claim 9, wherein the information transmitting means transmits the preliminary information in response to a request from the mobile device.

13. A computer-readable recording medium, wherein the recording medium stores the winner deciding program according to any one of claims 9 to 12.
